(19) United States
(12) Patent Application Publication
(10) Pub. No.: US 2004/0138945 A1
(43) Pub. Date: Jul. 15, 2004

(54) Method for reducing the cost of imaging for customers

(76) Inventors: Christopher Alan Adkins, Lexington, KY (US); Michael Clark Campbell, Lexington, KY (US); Jeffrey Ray Ehlert, Lexington, KY (US); Timothy Lowell Strunk, Lexington, KY (US)

Correspondence Address: Jacqueline M. Daspit, Lexmark International, Inc., Intellectual Property Law Dept., 740 West New Circle Road, Bldg. 082, Lexington, KY, 40550, US

(21) Appl. No.: 10/342,496

(22) Filed: Jan. 15, 2003

(51) Int. Cl. G06F 17/60

(52) U.S. Cl. 705/14

(57) ABSTRACT

A method for reducing the cost of imaging for customers includes the steps of establishing an imaging reward threshold value; determining a rate of consumption of a supply item; comparing the rate of consumption with the imaging reward threshold value; and, based on an outcome of the comparing step, determining whether the customer qualifies to receive an imaging reward.

### BACKGROUND OF THE INVENTION

1. Field of the Invention

The present invention relates to imaging, and, more particularly, to reducing the cost of imaging for customers.

2. Description of the Related Art

It has been long recognized that consumers respond favorably to receiving incentives for purchasing products. For example, local newspapers throughout the United States run advertising campaigns offering to potential customers a discount, in the form of a paper coupon that can be clipped and submitted at the point of retail sale to receive the discount on the purchased product. Also, it is known for manufacturers to have rebate programs, wherein following the sale, the customer submits a rebate form and proof of purchase to obtain a cash rebate on the purchase price.

Typically, however, such programs do not have the ability to track usage of a particular product or type of product and then reward the customer based on the amount of the product that is used so as to reduce the effective cost of the product to the customer.

Accordingly, what is needed in the art is a method for reducing the cost of imaging for customers.

### SUMMARY OF THE INVENTION

The present invention provides a method for reducing the cost of imaging for customers.

The invention, in one form thereof, includes the method steps of establishing an imaging reward threshold value; determining a rate of consumption of a supply item; comparing the rate of consumption with the imaging reward threshold value; and, based on an outcome of the comparing step, determining whether the customer qualifies to receive an imaging reward.

In another form thereof, the invention includes the method steps of establishing a database accessible by an e-commerce server for enrolling a customer's participation in an imaging rewards program; enrolling the customer in the imaging rewards program with the database via the e-commerce server; establishing an imaging reward threshold value; determining a rate of consumption of a supply item for an imaging apparatus; comparing the rate of consumption with the imaging reward threshold value; and, based on an outcome of the comparing step, determining whether the customer qualifies to receive an imaging reward.

An advantage of the present invention is that a good relationship with a customer can be maintained.

Another advantage is that customer loyalty can be rewarded.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system 10 for implementing the present invention.

FIG. 2 is a general flowchart representing one method for reducing a cost of imaging for a customer.

FIGS. 3A and 3B depict a general flowchart representing another method for reducing a cost of imaging for a customer.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION OF THE INVENTION

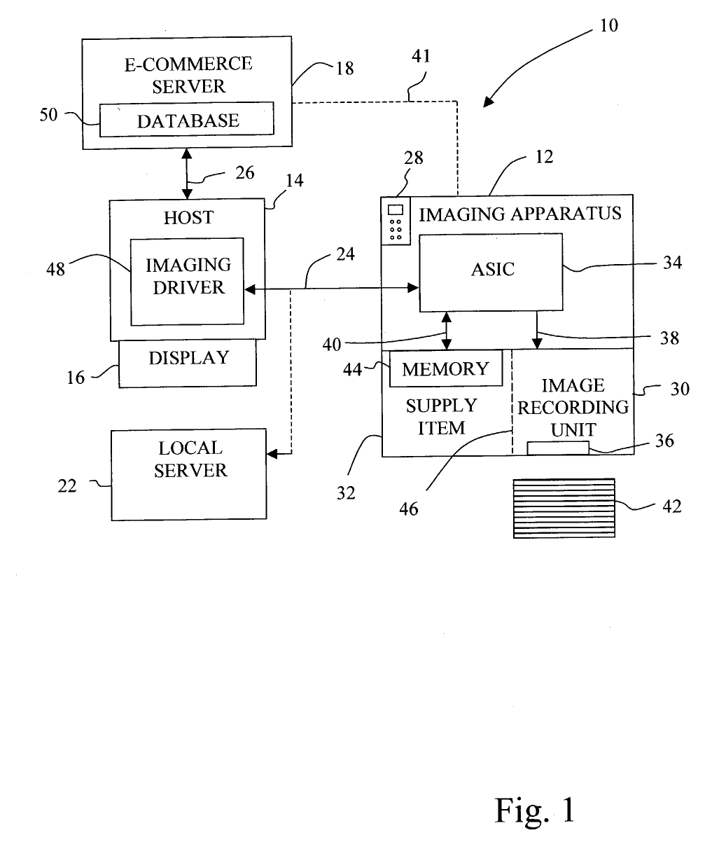

Referring now to the drawings, and particularly to FIG. 1, there is shown a diagrammatic depiction of a system 10 for implementing the present invention. System 10 includes an imaging apparatus 12, a host 14 with a display 16, an e-commerce server 18 and, optionally, a local server 22. Imaging apparatus 12 communicates with host 14 via a communications link 24. Also, in embodiments that include local server 22, local server 22 communicates with each of imaging apparatus 12 and host 14 via communications link 24, with the aid of the extension of communications link 24 depicted by a dashed line. E-commerce server 18 communicates with host 14 via a communications link 26.

Imaging apparatus 12 may include, for example, a user interface 28, an image recording unit 30, a supply item 32 and an Application Specific Integrated Circuit (ASIC) 34. ASIC 34 communicates with image recording unit 30 via a communications link 38. ASIC 34 communicates with supply item 32 via a communications link 40. Imaging apparatus 12 can be, for example, an ink jet printer and/or copier, or an electrophotographic printer and/or copier.

It is further contemplated that imaging apparatus 12 may be a stand-alone multifunction imaging device that is not attached to host 14, e-commerce server 18, or local server 22. The stand-alone multifunction imaging device may facilitate the imaging rewards program, described below, with only customer interaction via user interface 28. The stand-alone multifunction imaging device includes connectivity and processing capability sufficient to implement the various methods of the invention, as further described below. In some implementations, however, e-commerce server 18 may communicate directly with the stand-alone multifunction imaging device via a communication link 41, such as for example, a telephone line connection.

In the context of the examples for imaging apparatus 12 given above, image recording unit 30 can be, for example, an ink jet printhead unit or an electrophotographic printing unit, and includes an imaging head 36 used for forming an image on a substrate 42, such as a sheet of print media or a photoconductive member. For convenience, each type of substrate 42 will be referred to by the element number 42, for example, print media 42.

Supply item 32 can be, for example, an ink supply tank, an ink jet cartridge, a toner tank, or an electrophotographic process (EP) cartridge, each of which containing a supply of an imaging substance, such as for example ink or toner, that is consumed during an imaging process. Imaging apparatus 12 uses the imaging substance contained in supply item 32 to form an image on print media 42. As noted above, print media 42 can be, for example, sheets of paper, fabric or transparencies.

Those skilled in the art will recognize that image recording unit 30 and supply item 32 may be formed as individual discrete units, or may be combined in an integral unit, these options being depicted by dashed line 46.

Preferably, supply item 32 has mounted thereto a memory 44 for storing information relating to supply item 32, such as for example, a supply item identification number, a value representing an amount of usage of supply item 32, and a value representing time. For example, thirty-two or more bits in memory 44 may be reserved for the supply item identification number, which may be set by the manufacturer; eight or more bits may be used as a usage gauge to maintain a record of usage of supply item 32 with each bit representing a level of depletion of imaging substance from supply item 32; and seven or more time tracking bits may be used to represent time, such as for example, the amount of time since supply item 32 was first installed in imaging apparatus 12. By attaching memory 44 to supply item 32, in essence, information stored in memory 44 associated with supply item 32 can travel with supply item 32 from one imaging apparatus to another.

In implementations where supply item 32 is subject to a usage license, preferably, an initial supply amount of imaging substance contained in supply item 32 is greater than the licensed amount of the imaging substance. For example, the initial supply amount of the imaging substance contained in supply item 32 can be, for example, at least two times greater than the original licensed amount. It is important to note, however, that while the initial amount of imaging substance supplied with imaging apparatus 12 and/or supply item 32 is more than sufficient to accommodate one or more license renewals, the customer has been required to pay only for the licensed amount at the time of the original purchase.

Host 14 may be, for example, a personal computer including a display device 16, an input device (e.g., keyboard), a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 48 for imaging apparatus 12. Imaging driver 48 is in communication with ASIC 34 of imaging apparatus 12 via communications link 24. Imaging driver 48 serves to facilitate communications between imaging apparatus 12 and e-commerce server 18. In addition, imaging driver 48 serves in the traditional roll of providing formatted print data to imaging apparatus 12.

E-commerce server 18 provides, and has access to, a database 50 for enrolling a customer's participation in an imaging rewards program, and storing other related information. In one method of the invention, the database 50 of e-commerce server 18 is accessed via on-line communications over the Internet to enroll a customer's participation in an imaging rewards program. Further, the customer can access e-commerce server 18 via an Internet web site to access current information on various imaging rewards programs that are available and other information that a customer might find helpful to enhance their imaging experience.

Communications link 24 may be established by a direct cable or a wireless connection, or by a network connection such as for example an Ethernet local area network (LAN). Communications links 38 and 40 may be established by using standard electrical cabling or bus structures, or by wireless connections.

Communications link 26 is preferably established by an Internet connection, or via a wide area network (WAN). Alternatively, however, communications link 26 graphically represents a communication by a customer who physically visits the premises of e-commerce server 18, or a telephone link to e-commerce server 18.

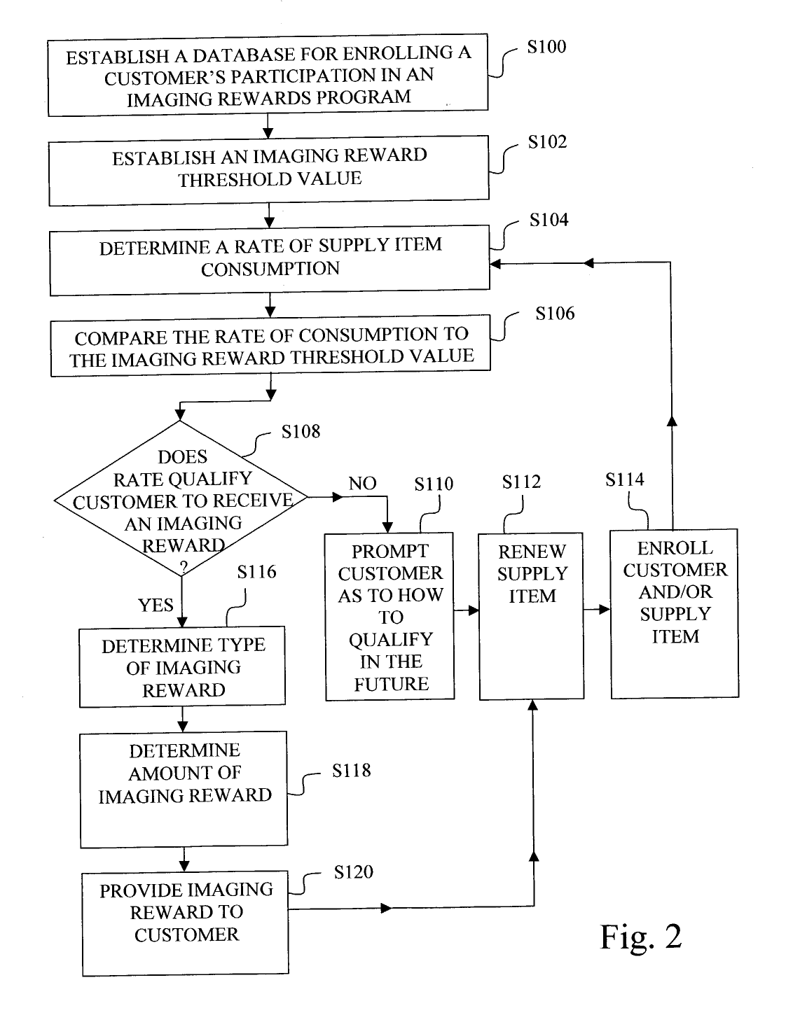

FIG. 2 is a general flowchart representing a method for reducing a cost of imaging for a customer.

At step S100, database 50 is established for enrolling a customer's participation in an imaging rewards program. In the example shown in FIG. 1, this database is established in e-commerce server 18, and is accessible via the Internet and e-commerce server 18. Alternatively, database 50 may be established in local server 22, host 14, or in imaging apparatus 12.

The customer will enroll in an imaging rewards program, such as at the time of the acquisition, e.g., purchase, of imaging apparatus 12 or supply item 32. Such an enrollment can be performed, for example, over the Internet via host 14 and e-commerce server 18, with the enrollment information being maintained in database 50. The enrollment can be performed automatically, i.e., without user intervention, based on information provided by the customer during the acquisition.

The imaging reward may, for example, be in the form of a discount provided to the customer for the acquisition of an additional supply item, up to a 100 percent discount, i.e., free. Such a discount may be conveyed to the customer, for example, via a coupon printed at imaging apparatus 12, a coupon mailed to the customer generated by e-commerce server 18 and database 50 established for enrolling the customer's participation in an imaging rewards program, or an electronic coupon maintained in database 50 with confirmation electronically transmitted to host 14. The acquisition of an additional supply item may be in the form of a renewal of supply item 32. The renewal may be in the form of a replacement for supply item 32, a number of physical replenishments of supply item 32, or, in a licensing implementation, by a virtual replenishment of supply item 32 through license renewal(s).

In another embodiment, the imaging reward may be in the form of reward points, wherein the reward points can be accumulated and used to obtain a discount on a subsequent acquisition of at least one of an additional supply item 32 or a new imaging apparatus 12. Such an acquisition may be, for example, via a purchase or a usage license.

In another embodiment, the imaging reward may be in the form of an amount of an additional supply item 32 that can be received for a fixed fee. The fixed fee may be determined at a time of enrolling the customer for participation in the imaging rewards program. The amount may be in the form of a number of supply item renewals. The number of renewals may be, for example, a number of replacements for supply item 32, a number of physical replenishments for supply item 32, or, in a licensing implementation, an amount of virtual replenishments of supply item 32 through license renewal(s).

In another embodiment, the imaging reward may be offered based on the type of imaging the customer is doing. As an example, imaging apparatus 12 can determine, either by media sensing or by user selection, the type of media that is being printed. Through communication with imaging apparatus 12, imaging driver 48 can maintain a history of media usage. If, for example, it is determined that the customer uses a considerable amount of photo paper, then the imaging reward granted could be in the form of an amount of free compatible photo paper.

At step S102, an imaging reward threshold value is established. The imaging reward threshold value will be a predetermined numerical value corresponding to the basis of the rate of supply item consumption determined in step S104. For example, the imaging reward threshold value may be a unitless value, or may be in the form of a value representing time and/or usage criteria. Time may be represented in terms of standard time units, such as hours, days or months. Alternatively, time may be represented in terms of non-standard units, such as a count of the number of clock cycles of a clocking device in imaging apparatus 12 or host 14. The imaging reward threshold value may be maintained, for example, in imaging apparatus 12, host 14 or supply item 32. In embodiments that utilize e-commerce server 18, the imaging reward threshold value alternatively may be maintained in database 50.

At step S104, a rate of consumption of supply item 32 is determined. The step S104 determination may be performed, for example, in imaging apparatus 12, host 14, e-commerce server 18 or local server 22. This determination will be performed at a predetermined time, such as for example, when a low level of an imaging substance, such as ink or toner, is identified in supply item 32, or when all of the time tracking bits in memory 44 have been set. The low level of imaging substance determination may be made, for example, by reading the usage gauge bits of memory 44, or by estimation, calculation or measurement of the amount of residual imaging substance in supply item 32, conducted by, for example, imaging apparatus 12 and/or imaging driver 48.

It is contemplated that the rate of consumption may be determined based on a variety of time and/or usage criteria. For example, the rate of consumption can be based on an amount of time required to use a specified amount of supply item 32; based on an amount of time between acquisitions of the supply item; based on an amount of use of the supply item, e.g., imaging substance volume depleted, during a specified amount of time; based on an amount of the supply item acquired, e.g., imaging substance volume acquired, during a specified amount of time; or, based on a quantity of the supply item, e.g., the number, acquired during a specified amount of time. The rate of consumption examples listed above will be described in more detail below with respect to exemplary implementations.

At step S106, the rate of consumption determined at step S104 is compared with the imaging reward threshold value established at step S102. This comparison can be performed, for example, in imaging apparatus 12 by ASIC 34 or in host 14 by imaging driver 48.

At step S108, based on an outcome of the comparing step S106, it is determined whether the customer qualifies to receive an imaging reward. For example, if the rate of consumption exceeds the imaging reward threshold value, the customer may be deemed to qualify for the imaging reward for which the customer is eligible. Those skilled in the art will recognize that other basis for the comparison could be used, e.g., if the rate of consumption is equal to the imaging reward threshold value, or if the imaging reward threshold value is less than the rate of consumption of the supply item. This determination may be made, for example, in imaging apparatus 12 by ASIC 34 or in host 14 by imaging driver 48.

If at step S108 it is determined that the customer does not qualify to receive an imaging reward, then at step S110 a prompt is given to the customer as to how the customer may qualify for the imaging reward in the future. The prompt may be displayed, for example, at display 16 of host 14 or user interface 28. Further, the prompt may include information that would be useful in imaging even at a rate that does not qualify for imaging rewards. For example, if the customer uses photo paper, the customer could be provided with a message that could state the types of photo paper that generally work best with the current imaging apparatus/supply item combination.

At step S112, imaging apparatus 12 detects when supply item 32 has been renewed. This renewal may be in the form of a supply item replenishment, supply item replacement, or a license renewal.

At step S114, the customer and/or the renewal supply item are enrolled in database 50 established for enrolling the customer's participation in the imaging rewards program, via imaging apparatus 12, host 14 and e-commerce server 18. Such enrollment may be performed automatically, upon supply item renewal or upon loading a new supply item 32. The process then returns to step S104.

If at step S108 it is determined that the customer does qualify to receive an imaging reward, then, at step S116 it is determined which type of imaging reward the customer is qualified to receive. As mentioned above, the type of imaging reward could be, for example, a discount provided to the customer for the acquisition of an additional supply item, up to a 100 percent discount, i.e., free; reward points; or some other type of supply item, such as print media, e.g., paper.

At step S118, the amount of the imaging reward is determined. As mentioned above, the amount of the imaging reward may be, for example, a percent reduction in cost over a full priced supply item, or a quantity of supply item renewals.

At step S120, the imaging reward is provided to the customer. The imaging reward may be conveyed to the customer physically or electronically. Examples of physical conveyance include via a coupon printed at imaging apparatus 12, a coupon mailed to the customer generated by e-commerce server 18 and database 50 established for enrolling the customer's participation in an imaging rewards program, or a supply item mailed to the customer. Examples of electronic conveyance include an electronic coupon maintained in database 50 with confirmation electronically transmitted to host 14, an electronic conveyance of reward points transmitted to host 14, or an electronic conveyance of a license renewal transmitted to host 14.

Following step S120, the process returns to step S112.

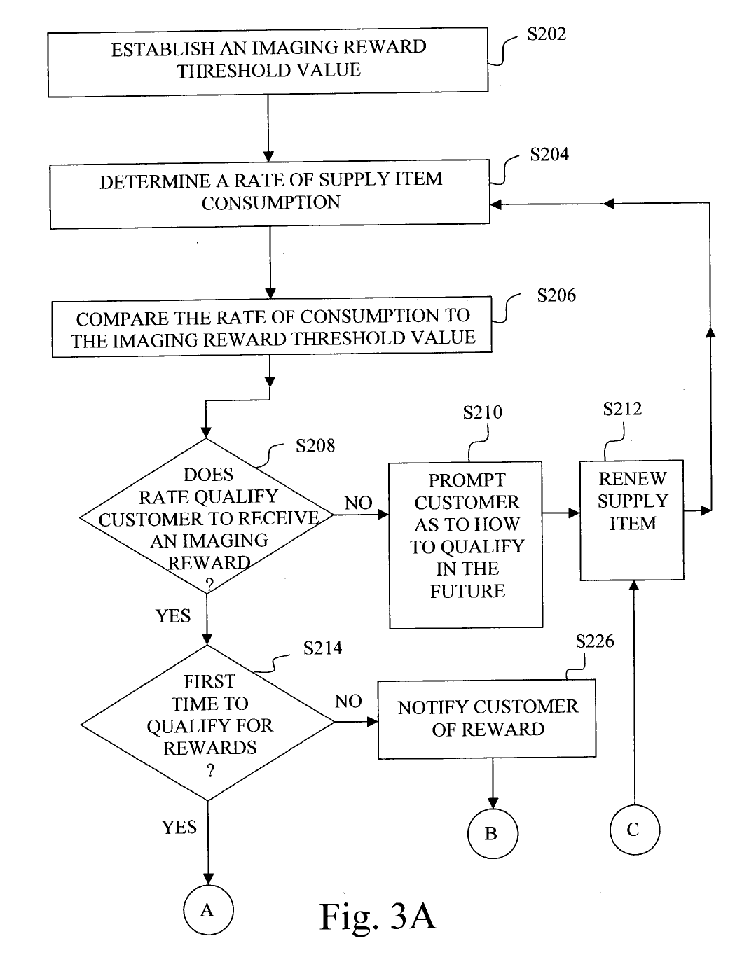

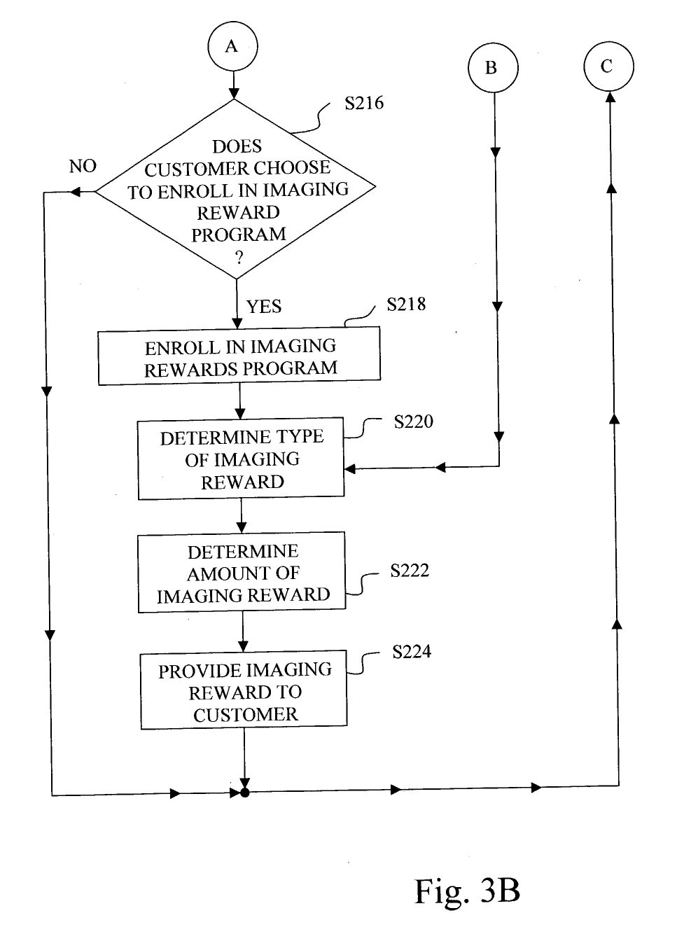

FIGS. 3A and 3B depict a general flowchart representing another method for reducing a cost of imaging for a customer using an imaging rewards program.

At step S202, an imaging reward threshold value is established. The imaging reward threshold value will be a predetermined numerical value corresponding to the basis of the rate of supply item consumption determined in step S204. For example, the imaging reward threshold value may be a unitless value, or may be in the form of a value representing time and/or usage criteria. Time may be represented in terms of standard time units, such as hours, days or months. Alternatively, time may be represented in terms of non-standard units, such as a count of the number of clock cycles of a clocking device in imaging apparatus 12 or host 14. The imaging reward threshold value may be maintained, for example, in imaging apparatus 12, host 14 or supply item 32. In embodiments that utilize e-commerce server 18, the imaging reward threshold value alternatively may be maintained in database 50.

At step S204, a rate of consumption of supply item 32 is determined. The step S204 determination may be performed, for example, in imaging apparatus 12, host 14, e-commerce server 18 or local server 22. This determination will be performed at a predetermined time, such as for example, when a low level of an imaging substance, such as ink or toner, is identified in supply item 32, or when all of the time tracking bits in memory 44 have been set. The low level of imaging substance determination may be made, for example, by reading the usage gauge bits of memory 44, or by estimation, calculation or measurement of the amount of residual imaging substance in supply item 32, conducted by, for example, imaging apparatus 12 and/or imaging driver 48.

It is contemplated that the rate of consumption may be determined based on a variety of time and/or usage criteria. For example, the rate of consumption can be based on an amount of time required to use a specified amount of supply item 32; based on an amount of time between acquisitions of the supply item; based on an amount of use of the supply item, e.g., imaging substance volume depleted, during a specified amount of time; based on an amount of the supply item acquired, e.g., imaging substance volume acquired, during a specified amount of time; or, based on a quantity of the supply item, e.g., the number, acquired during a specified amount of time. The rate of consumption examples listed above will be described in more detail below with respect to exemplary implementations.

At step S206, the rate of consumption determined at step S204 is compared with the imaging reward threshold value established at step S202. This comparison can be performed, for example, in imaging apparatus 12 by ASIC 34 or in host 14 by imaging driver 48.

At step S208, based on an outcome of the comparing step S206, it is determined whether the customer qualifies to receive an imaging reward. For example, if the rate of consumption exceeds the imaging reward threshold value, the customer may be deemed to qualify for the imaging reward for which the customer is eligible. Those skilled in the art will recognize that other basis for the comparison could be used, e.g., if the rate of consumption is equal to the imaging reward threshold value, or if the imaging reward threshold value is less than the rate of consumption of the supply item. This determination may be made, for example, in imaging apparatus 12 by ASIC 34 or in host 14 by imaging driver 48.

If at step S208 it is determined that the customer does not qualify to receive an imaging reward, then at step S210 a prompt is given to the customer as to how the customer may qualify for the imaging reward in the future. The prompt may be displayed, for example, at display 16 of host 14 or user interface 28. Further, the prompt may include information that would be useful in imaging even at a rate that does not qualify for imaging rewards. For example, if the customer uses photo paper, the customer could be provided with a message that could state the types of photo paper that generally work best with the current imaging apparatus/supply item combination.

At step S212, imaging apparatus 12 detects when supply item 32 has been renewed. This renewal may be in the form of supply item replenishment, supply item replacement, or a license renewal. Once step S212 has executed, the process returns to step S204.

If at step S208 it is determined that the customer does qualify to receive an imaging reward, then, at step S214 it is determined whether this is the first time for the customer to qualify for an imaging reward.

If at step S214 it is determined that this is not the first time for the customer to qualify for an imaging reward, then the process proceeds to step S226.

At step S226, the customer is notified of the qualification for an imaging reward, and the process proceeds to step S220.

If, at step S214 it is determined that this is the first time for the customer to qualify for an imaging reward, then the process proceeds to step S216.

At step S216, it is determined whether the customer chooses to enroll, i.e., participate, in the imaging rewards program. In other words, the customer can opt out of the imaging program by so indicating at step S216. At step S216, imaging apparatus 12 may cause information to be generated and displayed, for example on user interface 28 or on display 16, to encourage the customer's participation in the imaging rewards program. Also, imaging apparatus 12 may cause information to be generated and displayed that includes a notice to the customer that the customer can redeem the imaging reward, and how to do so.

If, at step S216, the customer chooses to opt out, the process proceeds to step S212.

If at step S216 the customer chooses to enroll in the imaging rewards program, then the process proceeds to step S218.

At step S218, the customer will enroll in an imaging rewards program. Such an enrollment can be performed, for example, directly in imaging apparatus 12 or host 14 by establishing an enrollment database in the associated memory. In other words, imaging apparatus 12 and host 14 will administer the imaging rewards program. Alternatively, the enrollment can occur over the Internet via host 14 and e-commerce server 18, with the enrollment information being maintained in database 50. As stated above, enrollment is optional, with the customer having been given the option to opt out of enrollment.

At step S220 it is determined which type of imaging reward the customer is qualified to receive. As mentioned above, the type of imaging reward could be, for example, a discount provided to the customer for the acquisition of an additional supply item, up to a 100 percent discount, i.e., free; reward points; or some other type of supply item, such as paper.

At step S222, the amount of the imaging reward is determined. As mentioned above, the amount of the imaging reward may be, for example, a percent reduction in cost over a full priced supply item, a number of reward points, a quantity of supply item renewals, or an amount of license extension.

At step S224, the imaging reward is provided to the customer. The imaging reward may be conveyed to the customer physically or electronically. Examples of physical conveyance include via a coupon printed at imaging apparatus 12, a coupon mailed to the customer generated by e-commerce server 18 and database 50 established for enrolling the customer's participation in an imaging rewards program, or a supply item mailed to the customer. Examples of electronic conveyance include an electronic coupon maintained in database 50 with confirmation electronically transmitted to host 14, an electronic conveyance of reward points transmitted to host 14, or an electronic conveyance of a license renewal transmitted to host 14.

Following step S224, the process returns to step S212.

The following are exemplary implementations of the methods for reducing a cost of imaging to a customer as described above with respect to FIGS. 2, 3A and 3B.

Exemplary Implementation 1: Supply Item Discount Imaging Rewards Program

In Exemplary Implementation 1, a customer is offered a discount on the next supply item purchase, such as supply item 32, based on the time taken to use the current supply item. Time may be measured, for example, using the date of supply item installation, or the amount of time counted since the time of installation. The less time taken for the current supply item, the greater the discount offered on the next item. This allows the manufacturer to enhance the amount of the imaging reward as a customer's use increases.

Table 1 depicts by example the concept of the Supply Item Discount Imaging Rewards Program.

TABLE 1
Supply Item Discount Imaging Rewards Program

| Time taken to use | Discount on next |
|---|---|
| current supply item | supply item |
| Less than 1 month | 15% |
| 1-2 months | 12% |
| 2-4 months | 10% |
| 4-6 months | 8% |
| 6-8 months | 5% |

As shown in Table 1, if a customer's usage rate is consistent, then the customer can come to expect a consistent price on supply items 32. As shown, the customer can immediately gain the benefits of this discount on the first supply item purchase.

If the customer purchases supply item 32 from the manufacturer or original equipment manufacturer (OEM) directly through an e-commerce transaction via e-commerce server 18, for example, then the discount can be determined and applied immediately to the purchase of supply item 32. If the customer purchases supply item 32 through a retail chain, for example, a coupon can be used for the next purchase of supply item 32.

With respect to the method depicted in FIG. 2, to enhance the ease of receiving the imaging reward, the customer can enroll for participation in the Supply Item Discount Imaging Reward Program at the time of the purchase of imaging apparatus 12 or supply item 32. Such an enrollment can be performed, for example, over the Internet via host 14 and e-commerce server 18, with the enrollment information being maintained in database 50. The enrollment can be performed automatically, i.e., without user intervention. During the enrollment process, the e-commerce server 18 verifies that the current installed supply item 32 is not close to empty. Then, when imaging apparatus 12 determines that supply item 32 is empty or close to empty, the imaging apparatus 12 prompts the customer to purchase a new supply item via, for example, a message posted on display 16. Imaging apparatus 12 then passes the determination on to e-commerce server 18, and e-commerce server 18 verifies that the supply item 32 installed during enrollment is empty, or close to empty. Once verified, e-commerce server 18 determines the discount based upon the time taken to use the supply item 32 installed during enrollment, in accordance with the data depicted in Table 1.

Once the new supply item 32 is installed, system 10 would automatically enroll the new supply item 32 with e-commerce server 18, and the discount program would be available for future purchases as well.

It is contemplated that system 10 can enroll either supply item 32 or imaging apparatus 12. If supply item 32 is enrolled then the customer can receive the discount on the supply item regardless of what imaging apparatus uses the supply item. Alternatively, if imaging apparatus 12 is enrolled then the same supply item needs to be in imaging apparatus 12 during the enrollment process and during the discount acquisition.

With respect to the method of FIGS. 3A and 3B, enrollment is optional, with the customer being given the option to opt out of the program. If, however, the customer chooses to participate in the imaging rewards program, the consumer can enroll, for example, via host 14. Depending on how the imaging rewards program is administered, the enrollment can be recorded in any one of imaging apparatus 12, host 14, local server 22 or database 50 of e-commerce server 18 serving as a program administration unit. With the method of FIGS. 3A and 3B, the enrollment is not performed automatically, i.e., enrollment requires user input. During the enrollment process, the program administration unit, e.g., imaging apparatus 12, host 14, local server 22 or e-commerce server 18, verifies that the current installed supply item 32 is not close to empty. Then, when imaging apparatus 12 determines that supply item 32 is empty or close to empty, the imaging apparatus 12 prompts the customer to purchase a new supply item via, for example, a message posted on display 16. Imaging apparatus 12 then passes the determination to the program administration unit, which verifies that the supply item 32 installed during enrollment is empty, or close to empty. Once verified, program administration unit determines the discount based upon the time taken to use the supply item 32 installed during enrollment, for example, in accordance with the data depicted in Table 1.

Once the new supply item 32 is installed, system 10 would automatically enroll the new supply item 32 with e-commerce server 18, and the discount program would be available for future purchases as well.

Exemplary Implementation 2: Free Supply Imaging Rewards Program

In Exemplary Implementation 2, a customer is offered free supply items based on the frequency of usage, e.g., amount of usage of supply items during a specified period of time.

With respect to the method of FIG. 2, for example, once the customer enrolls for this program with e-commerce server 18, and due to the automatic communication of information from imaging apparatus 12 to e-commerce server 18, no further customer interaction is required. The customer will automatically receive a new supply item 32 in the mail when they qualify for the next imaging reward, as determined by e-commerce server 18.

Table 2 depicts by example the concept of the Free Supply Imaging Rewards Program.

TABLE 2
Free Supply Imaging Rewards Program

| Number Of Supply | Time Taken To Use | |
|---|---|---|
| Items Purchased | Supply Item | Equivalent Discount |
| 6 | 1 month | 14% |
| 7 | 3 months | 12.5% |
| 8 | 6 months | 11% |
| 9 | 16 months | 10% |
| 10 | 24 months | 9% |

As shown in Table 2, for example, if a customer uses eight supply items within a six-month period, the manufacturer will provide to the customer a new supply item for no cost. This will give the customer an equivalent discount of 11 percent.

E-commerce server 18 will track the number of supply items 32 used in each imaging apparatus 12. When imaging apparatus 12 contacts e-commerce server 18, during installation and when the supply item is depleted, imaging apparatus 12 will send to e-commerce server 18 the serial numbers of the imaging apparatus 12 and supply item 32, along with the appropriate message (installation or imaging substance low). It is contemplated that the manufacturer may use recycled supply items as the free supply item in the Free Supply Imaging Rewards Program.

With respect to the method of FIGS. 3A and 3B, the administration of the Free Supply Imaging Rewards Program is not automatic, since enrollment is optional, with the customer being given the option to opt out of the program. If, however, the customer chooses to participate in this imaging rewards program, the consumer can enroll, for example, via host 14. Depending on how the imaging rewards program is administered, the enrollment can be recorded in any one of imaging apparatus 12, host 14, local server 22 or database 50 of e-commerce server 18 serving as a program administration unit. Thereafter, once the criteria for qualifying for the free supply item is established, the program administration unit can contact the manufacturer to provide the information needed to secure the free supply item. Alternatively, the program administration unit can post the information needed by the manufacturer to one of display 15 or user interface 28, and the customer can relay that information, e.g., by telephone, email or e-commerce server 18, to the manufacturer for securing the free supply item. The manufacturer will respond by mailing to the customer the new supply item.

Exemplary Implementation 3: Reward Points Imaging Rewards Program

In Exemplary Implementation 3, a customer will receive reward points for the purchase of each supply item 32. When the customer accumulates a predetermined amount of reward points, the customer can apply those points toward a free supply item 32, a free imaging apparatus 12 or a discount. In this program, for example, the more points the customer accumulates during a year, the less amount of points is needed to receive a free supply item 32.

Table 3 depicts by example the concept of the Reward Points Imaging Rewards Program.

TABLE 3
Reward Points Imaging Rewards Program

| | Points Needed/Year | Points Needed For |
|---|---|---|
| Reward Level | To Reach Level | Free Supply |
| Platinum | 800 pts | 200 pts |
| Gold | 600 pts | 300 pts |
| Silver | 400 pts | 400 pts |
| Bronze | 250 pts | 500 pts |

As shown in Table 3, for example, each supply item 32 purchased would give the customer 100 points. If the customer accumulated 600 points in a year, then that customer would be in the “Gold” reward level. That customer would then be able to redeem a new supply with 300 points. In this system, the customer could also accumulate points to be applied toward the purchase on a new imaging apparatus 12. Depending on how the imaging rewards program is administered, the reward points can be tracked in any one of imaging apparatus 12, host 14, local server 22 or database 50 of e-commerce server 18 serving as a program administration unit. Thereafter, once the criteria for qualifying for a particular reward level is achieved, the program administration unit can contact the manufacturer to supply the information needed to secure the free supply item or discount associated with the particular reward level. Alternatively, the program administration unit can post the information needed by the manufacturer to one of display 15 or user interface 28, and the customer can relay that information, e.g., by telephone, email or e-commerce server 18, to the manufacturer for securing the reward points imaging reward. The manufacturer will respond by transferring to the customer the new supply item or discount. It is contemplated that the new supply item may be a recycled supply item.

Exemplary Implementation 4: Unlimited Printing Imaging Rewards Program

In Exemplary Implementation 4, a customer is offered unlimited printing for a monthly fee. The fixed fee is determined at a time of enrolling the customer for participation in said imaging rewards program. The Unlimited Printing Imaging Rewards Program would allow a customer to receive a new supply item, such as supply item 32, after returning a used supply item. The customer could request up to two supply items at a time. However, the manufacturer would only send a replacement supply item 32 to the customer after the used supply item is received. The maximum number of supply items available per month will be based on the time needed for shipping as well as the time needed for processing the used supply item and sending out the new supply item.

Program enrollment and tracking of the use of supply items 32 with imaging apparatus 12 can occur as previously described, consistent with the methods of FIG. 2 or FIGS. 3A and 3B. However, as an enhancement, each supply item 32 can contain a specific identifier such that only an imaging apparatus 12 enrolled in the Unlimited Printing Imaging Rewards Program could use that particular supply item 32. This identifier could be an electrical code stored, for example, in the electronic memory 44 of supply item 32. When a customer enrolls in this program, a command would be sent by the program administration unit to imaging apparatus 12, so as to enable imaging apparatus 12 to use supply items 32 available through the Unlimited Printing Imaging Rewards Program.

Exemplary Implementation 5: Limited Printing for a Monthly Fee Imaging Rewards Program

In Exemplary Implementation 5, a customer is offered limited printing for a monthly fee. This program would allow a customer to print up to a predetermined limit for a monthly fee. If the customer printed more than the limit there would be an additional charge based on the amount of supply item 32 used. Through supply item usage tracking via system 10, once supply item 32 was near empty, a new supply item would automatically be sent to the customer, in the manner consistent with respect to the methods of FIG. 2 or FIGS. 3A and 3B.

Exemplary Implementation 6: Centralized Billing for Business Customers

In Exemplary Implementation 6, a business customer is offered the opportunity to purchase supply items 32 for all imaging apparatus 12 used in that business based on the total number of supply items 32 used during a specified time period. The business customer would be charged a price based on the amount of supply item 32 used in a month. This amount could be based on pages or volume of imaging substance consumed.

Table 4 shows an example of the cost per page breakdown if a business owned 25 printers.

TABLE 4
Cost Per Page Breakdown

| Pages per Month | |
|---|---|
| (25 Printers) | Cost Per Page |
| >25,000 | $.05 |
| 15,000 | $.06 |
| 10,000 | $.07 |
| 5,000 | $.08 |
| <5,000 | $.09 |

For example, if a business used 12,000 pages in a month they would be charged $840, i.e., (12,000*$0.07). The manufacturer could automatically send new supply items 32, at no additional cost to the business, when a particular imaging apparatus 12 was low on supply. If the business customer chose to lease the imaging apparatus, then the business customer could expect a consistent monthly charge for total imaging cost.

A centralized server, such as local server 22, is installed at the place of business, for example. Alternatively, server 22 could be located at the imaging apparatus manufacturer's site. Imaging apparatus 12 would periodically connect to server 22 to send data corresponding to the amount of supply item 32 that was used, to request a new supply item from the manufacturer, or to query if imaging apparatus 12 can continue imaging. If server 22 is installed at the place of business, then server 22 will contact the manufacturer periodically with the total amount of supply item 32 used, request new supply items, and query if the business payment for imaging is up to date.

While this invention has been described with respect to several possible implementations, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for reducing a cost of imaging to a customer, comprising the steps of:
establishing an imaging reward threshold value;
determining a rate of consumption of a supply item;
comparing said rate of consumption with said imaging reward threshold value; and,
based on an outcome of said comparing step, determining whether said customer qualifies to receive an imaging reward.

2. The method of claim 1, further comprising the step of establishing a database for enrolling a customer's participation in an imaging rewards program.

3. The method of claim 2, wherein said database is established at an e-commerce server.

4. The method of claim 1, further comprising the step of giving said customer an option to opt out of participating in an imaging rewards program providing said imaging reward.

5. The method of claim 4, further comprising the step of enrolling at least one of said supply item and said customer in said imaging rewards program.

6. The method of claim 1, wherein if said customer qualifies for said imaging reward, then performing the step of providing to said customer information to encourage participation in an imaging rewards program.

7. The method of claim 1, wherein if said customer qualifies for said imaging reward, then performing the step of generating a notice to said customer that said customer can redeem said imaging reward.

8. The method of claim 1, wherein said rate of consumption is based on an amount of time required to use a specified amount of said supply item.

9. The method of claim 1, wherein said rate of consumption is based on an amount of time between acquisitions of said supply item.

10. The method of claim 1, wherein said rate of consumption is based on an amount of use of said supply item during a specified amount of time.

11. The method of claim 1, wherein said rate of consumption is based on a volume of said supply item acquired during a specified amount of time.

12. The method of claim 1, wherein said rate of consumption is based on a quantity of said supply item acquired during a specified amount of time.

13. The method of claim 1, wherein said step of determining said rate of consumption of said supply item is performed in an imaging apparatus.

14. The method of claim 13, wherein a discount is provided to said customer as a coupon that is printed at said imaging apparatus.

15. The method of claim 1, wherein said step of determining said rate of consumption of said supply item is performed in a host.

16. The method of claim 15, wherein a discount is provided to said customer as a coupon that is printed at an imaging apparatus associated with said host.

17. The method of claim 1, wherein said step of determining a rate of consumption of said supply item is performed in an e-commerce server.

18. The method of claim 17, wherein a discount is provided to said customer as a coupon generated at said e-commerce server and supplied to said customer.

19. The method of claim 18, wherein said coupon is supplied to said customer in one of an electronic form and a printed form.

20. The method of claim 1, further comprising the step of determining a type of said imaging reward that said customer is qualified to receive.

21. The method of claim 1, wherein said imaging reward is a discount provided to said customer for the acquisition of an additional supply item.

22. The method of claim 1, wherein said imaging reward is at least one free supply item.

23. The method of claim 1, wherein said imaging reward is reward points, wherein said reward points can be accumulated and used to obtain a discount on a subsequent acquisition of at least one of an additional supply item or a new imaging apparatus.

24. The method of claim 23, wherein said acquisition is a purchase.

25. The method of claim 23, wherein said acquisition is a usage license.

26. The method of claim 1, wherein said imaging reward is an amount of an additional supply item that can be received for a fixed fee.

27. The method of claim 26, wherein said fixed fee is determined at a time of enrolling said customer for participation in an imaging rewards program.

28. The method of claim 1, further comprising the step of, upon supply item renewal, automatically enrolling said customer for participation in an imaging rewards program.

29. The method of claim 1, further comprising the step of determining an amount of said imaging reward.

30. The method of claim 1, wherein said imaging reward is unlimited printing for a fixed fee.

31. The method of claim 1, wherein said imaging reward is limited printing for a fixed fee.

32. A method for reducing a cost of imaging to a customer, comprising the steps of:
establishing a database accessible by an e-commerce server for enrolling a customer's participation in an imaging rewards program;
enrolling said customer in said imaging rewards program with said database via said e-commerce server;
establishing an imaging reward threshold value;
determining a rate of consumption of a supply item for an imaging apparatus;
comparing said rate of consumption with said imaging reward threshold value; and,
based on an outcome of said comparing step, determining whether said customer qualifies to receive an imaging reward.

33. The method of claim 32, wherein said step of determining said rate of consumption of said supply item is performed in a host.

34. The method of claim 32, wherein said e-commerce server communicates automatically with said imaging apparatus, and said step of determining said rate of consumption of said supply item is performed by said e-commerce server.

35. The method of claim 32, further comprising the step of determining a type of said imaging reward that said customer is qualified to receive.

36. The method of claim 32, wherein said imaging reward is a discount provided to said customer for the acquisition of an additional supply item.

37. The method of claim 32, wherein said imaging reward is at least one free supply item.

38. The method of claim 32, wherein said imaging reward is reward points, wherein said reward points can be accumulated and used to obtain a discount on a subsequent acquisition of at least one of an additional supply item or a new imaging apparatus.

39. The method of claim 38, wherein said acquisition is a purchase.

40. The method of claim 38, wherein said acquisition is a usage license.

41. The method of claim 32, wherein said imaging reward is in the form of an amount of an additional supply item that can be received for a fixed fee.

42. The method of claim 41, wherein said fixed fee is determined at a time of enrolling said customer for participation in said imaging rewards program.

43. The method of claim 32, wherein said customer is automatically enrolled for participation in said imaging rewards program upon loading a new supply item.

44. The method of claim 32, wherein said customer is automatically enrolled for participation in said imaging rewards program upon a purchase of at least one of a new imaging apparatus and a new supply item.
